(19) United States
(12) Patent Application Publication
(10) Pub. No.: US 2021/0214658 A1
(43) Pub. Date: Jul. 15, 2021

(54) NON-SCRATCH COMPOSITION AND ABRASIVE CLEANING ARTICLE

(71) Applicant: 3M INNOVATIVE PROPERTIES COMPANY, St Paul, MN (US)

(72) Inventors: Kaylee R. Schmall, Minneapolis, MN (US); Myhanh T. Truong, Cottage Grove, MN (US); Yifan Zhang, Woodbury, MN (US); David G. Baird, Woodbury, MN (US); Irem Bolukbasi, St. Paul, MN (US); Kyle C. Bryson, Maplewood, MN (US); Lylien Zhang, South St. Paul, MN (US)

(21) Appl. No.: 17/054,278

(22) PCT Filed: Apr. 29, 2019
(86) PCT No.: PCT/IB2019/053486

§ 371 Date: Nov. 10, 2020

Related U.S. Application Data
(60) Provisional application No. 62/669,797, filed on May 10, 2018.

(51) Int. Cl. C11D 17/04; C11D 17/00; C11D 3/37; A47L 13/17

(52) U.S. Cl. CPC C11D 17/049; A47L 13/17; C11D 3/37; C11D 17/0013

(57) ABSTRACT

The present invention is a cleaning article including a substrate and organic abrasive particles dispersed on the substrate. The organic abrasive particles have a Mohs hardness of between about 2.0 and about 5.0. The cleaning article cleans greater than about 0.9 panels in 1,000 cycles and has a Schieffer Scratch performance rating of less than or equal to about 3.5.

### FIELD OF THE INVENTION

The present invention is related to the field of scouring. In particular, the present invention is a scouring composition and an abrasive cleaning article that results in minimal to no scratching.

### BACKGROUND

Conventional nonwoven abrasive articles are typically made of nonwoven webs constituted of a network of synthetic fibers or filaments which provide surfaces upon which abrasive particles are adhesively attached by a binder. In another known process for the production of nonwoven abrasive articles, a pre-bond coat is applied to the fibrous mat followed by a make coat which contains abrasive particles. The pre-bond coat may be applied by roll coating and the make coat may be applied by spraying either a single side or each side of the web. Current commercial scouring pads, often used in kitchen cleaning, include Scotch-Brite™ brand products comprised of nonwoven lofty open mats formed from randomly disposed fibers which are thermal bonded with a binder slurry that contain an abrasive. For example, the Scotch-Brite™ Heavy Duty brand scouring pad sold by 3M Company of Saint Paul, Minn. includes abrasive minerals having a high Mohs hardness, such as aluminum oxide. While these pads are extremely efficient at cleaning, they can be too abrasive for cleaning more delicate surfaces in a household kitchen, including non-stick cookware, plastic eating utensils, glass, and the like, resulting in scratches on the surface of the article being cleaned.

Another commercial scouring pad is sold under the trade name “Scotch-Brite™ Non-Scratch” by 3M Company of Saint Paul, Minn. Such pads are also comprised of nonwoven lofty open mats formed from randomly disposed fibers which are thermal bonded with a binder slurry. However, the Scotch-Brite™ Non-Scratch brand scouring pad does not include abrasive materials. The absence of abrasive materials in the scouring pad allows the pads to clean more delicate surfaces with minimal to no scratching. However, while the absence of abrasive materials in the scouring pad results in minimal to no scratching, the absence of abrasive materials also results in reduced cleaning effectiveness compared to scouring pads including abrasive materials.

### SUMMARY

In one embodiment, the present invention is a cleaning article including a substrate and organic abrasive particles dispersed on the substrate. The organic abrasive particles have a Mohs hardness of between about 2.0 and about 5.0. The cleaning article cleans greater than about 0.9 panels in 1,000 cycles and has a Schieffer Scratch performance rating of less than or equal to about 3.5.

In another embodiment, the present invention is a cleaning article including a substrate and a coating on the substrate. The coating includes a resin binder and organic abrasive particles. The organic abrasive particles have a Mohs hardness of between about 2.0 and about 5.0. The cleaning article cleans greater than about 0.9 panels in 1,000 cycles and has a Schieffer Scratch performance rating of less than or equal to about 3.5.

In yet another embodiment, the present invention is a cleaning composition. The cleaning composition between about 0.1 and about 90 weight percent organic abrasive particles, between about 0.1 and about 80 weight percent abrasive particles, and between about 0 and about 30 weight percent carrier. The organic abrasive particles have a Mohs hardness of between about 2.0 and about 5.0. The cleaning composition cleans about 1 panel in about 150 cycles or less, has a Slurry Scratch performance rating of less than about 5, and has a Polish Performance rating of greater than 0.

In yet another embodiment, the present invention is a coating composition for a cleaning article. The coating composition includes between about 10 and about 90 weight percent resin binder and between about 10 and about 90 weight percent organic abrasive particles. The organic abrasive particles have a Mohs hardness of between about 2.0 and about 5.0. The cleaning article cleans greater than about 0.9 panels in 1,000 cycles and has a Schieffer Scratch performance rating of less than or equal to about 3.5.

### DETAILED DESCRIPTION

The present invention is a coating composition and a cleaning article including the coating composition. The present invention is also a cleaning composition having organic abrasive particles incorporated into a carrier that can efficiently clean a surface with minimal to no scratching. The coating composition, cleaning article including the coating composition, and cleaning composition include organic abrasive particles that can efficiently clean a surface with minimal to no scratching. The organic abrasive particles are non-scratch and have a Mohs hardness of between about 2.0 and about 5.0.

The coating composition of the present invention is formed of a curable binder resin and organic abrasive particles. The curable binder precursor is used to bind the abrasive particles to the substrate. The binder precursor is preferably capable of flowing sufficiently so as to be able to coat a surface. Solidification of the binder precursor may be achieved by curing (e.g., polymerization and/or cross-linking), by drying (e.g., driving off a liquid), and/or by cooling. The binder precursor may be an organic solvent borne, a water-borne, or a 100 percent solids (i.e., substantially solvent free) composition. Both thermoplastic and/or thermosetting polymers, or materials, as well as combinations thereof, may be used as binder precursors. Upon curing of the binder precursor, the curable coating is converted into a cured bond system.

In one embodiment, the binder precursor is either a condensation curable resin or an addition polymerizable resin. In one embodiment, the binder precursor is a curable organic material. An example of a binder resin suitable for the present invention is a thermally curable resin. Examples of thermally curable resins include, but are not limited to: phenolic resins, urea formaldehyde resins, urethane resins, melamine resins, epoxy resins, bismaleimide binders, vinyl ether resins, aminoplast resins having pendant alpha, beta unsaturated carbonyl groups, acrylate resins, acrylated isocyanurate resins, isocyanurate resins, acrylated urethane resins, acrylated epoxy resins, alkyd resins, and mixtures thereof. For example, the coating composition may include a urea formaldehyde resin precursor. The term “urea formaldehyde resin precursor” refers to compounds which may include monomers or oligomers which are curable in the presence of an appropriate catalyst to provide fully cured urea formaldehyde resins which are solid polymeric materials that are cross-linked. Urea-formaldehyde resin precursor compositions useful in the present invention may be prepared by the reaction of urea with formaldehyde. In one embodiment, the addition polymerizable resins can be ethylenically unsaturated monomers and/or oligomers. Other binders that can be used in the present invention to adhere the abrasive particles to the substrate include, but are not limited to: hide glue, varnish, polyurethane resins, and radiation cured crosslinked acrylate binders. In one embodiment, the coating composition includes between about 10 wt % and about 90 wt % resin binder and between about 90 wt % and about 10 wt % organic abrasive particles; particularly between about 15 wt % and about 80 wt % resin binder and between about 20 wt % and about 85 wt % organic abrasive particles; and more particularly between about 20 wt % and about 65 wt % resin binder and between about 35 wt % and about 80 wt % organic abrasive particles.

The binder resin may also include a mild abrasive. Examples of suitable mild abrasives include, but are not limited to: talc, calcium carbonate, melamine formaldehyde, calcium silicate, pumice, kaolins, clay, etc. When included, the mild abrasive is generally employed in an amount up to about 50 wt % of the dry weight of the binder resin, particularly up to about 30 wt % of the dry weight of the binder resin, and more particularly up to about 15 wt % of the dry weight of the binder resin. The presence of the mild abrasive contributes towards the flexural modulus of the cured binder system.

The binder resin formulations used in the present invention may also include a toughening agent. In one embodiment, the toughening agent is a polymer latex selected from, for example: vinyl acetate, vinyl chloride, ethylene, styrene butyl acrylate and vinyl ester of versatic acid, polymers, and copolymers. The glass transition temperature of the polymers used as toughening agents is typically in the range of 0° C. to about 50° C.

Other materials can be added to the binder resin for special purposes, including, but not limited to: grinding aids, fibers, lubricants, wetting agents, surfactants, pigments, dyes, coupling agents, plasticizers, antistatic agents, antimicrobial agents, and suspending agents. Examples of antistatic agents include, but are not limited to: graphite, carbon black, conductive polymers, humectants, vanadium oxide, and the like.

The organic abrasive particles of the present invention are formed from a resin binder. The curable resin binder precursor functions to give bulk material properties to the resulting organic abrasive as well as functions to bind mild abrasives particles, when present, into the organic abrasive to form the organic abrasive particles. The binder includes a binder precursor that has been cured. The abrasive agglomerate particles of the present invention may utilize abrasive grains that are identical or are different in size. The organic abrasive particles can have any geometry or size and may be precise or irregular and random. The organic abrasive particles can also be precision shaped grains (PSG), such as those described in 3M Ref No. 80776US002 (filed on May 10, 2018), which is hereby incorporated by reference. For example, precisely shaped grains may be any three-dimensional shape such as, but not limited to: a pyramid, cone, block, cube, sphere, cylinder, rod, triangle, hexagon, square, and the like. In addition, any combination of shapes of abrasive particles may be used in the cleaning articles of the present invention. In one embodiment, the organic abrasive particles are precision shaped grains that are triangular in shape, having a length of between about 100 and about 800 microns, a width of between about 100 and about 800 microns, and a depth of between about 50 and about 500 microns.

Other materials can be added to the organic abrasive particles for special purposes, including, but not limited to: cross-linkers, plasticizers, mild-abrasives, acid catalysts, surfactants, antibacterial agents, anti-fungal agents, compounds with magnetic properties, and glitter. Cross-linkers promote cross-linking of binder precursors. Plasticizers are curable binder precursor that can be added to the resin binder system to promote plasticity and reduce brittleness. Mild abrasives can be added to contribute to the flexural modulus of the cured binder system and can also function as a mild abrasive agent. Acid catalysts have the ability to catalyze the reaction of a binder precursor. Surfactants can be used to modify the surface tension of the formulation or function as a cleaning agent. Antimicrobial agents can lend antimicrobial efficacy to the cleaning article. In one embodiment, the organic abrasive particles include between about 35 wt % and about 100 wt % resin binder, up to about 15 wt % cross-linker, up to about 65 wt % plasticizer, up to about 65 wt % mild-abrasive, up to about 10 wt % acid catalyst, and up to about 10 wt % surfactant. Particularly, the organic abrasive particles may include between about 45 wt % and about 90 wt % resin binder, up to about 10 wt % cross-linker, between about 5 wt % and about 30 wt % plasticizer, between about 5 wt % and about 45 wt % mild-abrasive, up to about 8 wt % acid catalyst, and up to about 8 wt % surfactant. More particularly, the organic abrasive particles may include between about 65 wt % and about 85 wt % resin binder, up to about 8 wt % cross-linker, between about 5 wt % and about 20 wt % plasticizer, between about 10 wt % and about 30 wt % mild-abrasive, up to about 5 wt % acid catalyst, and up to about 5 wt % surfactant.

The organic abrasive particles are made by sequentially adding the components in a mixer and mixing. The components are then cured and crushed to the desired size. In one embodiment, the organic abrasive particles are crushed to a size ranging from about 50 to about 500 microns, and particularly from about 100 to about 500 microns.

Precisely shaped particles of the invention may be generally made by following the process as described in 3M Ref. No. 80776US002, which his hereby incorporated by reference. Generally, the precisely shaped particles are made by forming a mixture containing at least a binder precursor. The binder resin may also include a mild abrasive, toughening agents, and other materials added to the binder resin for special purposes, including, but not limited to: grinding aids, fibers, lubricants, wetting agents, surfactants, pigments, dyes, coupling agents, plasticizers, antistatic agents, antimicrobial agents, and suspending agents. The mixture is coated into precisely shaped cavities of a production tool, at least partially curing the binder precursor, and then removing the precisely shaped particles from the cavities of the production tool. The mixture can be formed using any conventional technique such as high shear mixing, air stirring, or tumbling. A vacuum can also be used during mixing so as to minimize air entrapment. The mixture may be introduced into the cavities of the production tool using techniques such as gravity feeding, pumping, die coating, or vacuum drop die coating.

The organic abrasive articles must be hard enough to sufficiently clean a surface while minimizing any scratching of the surface. One measurement of hardness is through the Mohs' scale of mineral hardness. The Mohs' scale of hardness characterizes the scratch resistance of a mineral through the ability of a harder material to scratch a softer material. In one embodiment, the organic abrasive particles used in the coating composition of the present invention have a Mohs hardness of between about 2.0 and about 5.0, particularly between about 2.0 and about 4.0, and more particularly between about 2.5 and about 3.5.

Other materials can be added to the coating composition for special purposes, including, but not limited to: viscosity modifiers, surfactants, plasticizers, cross-linkers, antifoaming agents, mild abrasives, abrasives, pigments, acid catalysts, antifungal agents, and antimicrobial agents. Viscosity modifiers can be used to modify the viscosity of the formulation. Antifoaming agents can be used to defoam the formulation. Pigments can be added to give color to formulation. Antimicrobial agents can lend antimicrobial efficacy to an article and antifungal agents can lend antifungal efficacy to an article. In one embodiment, the coating composition may include between about 5 wt % and about 90 wt % resin binder, between about 90 wt % and about 10 wt % organic abrasive particles, up to about 10 wt % viscosity modifier, up to about 10 wt % surfactant, up to about 50 wt % plasticizer, up to about 20 wt % cross-linker, up to about 5 wt % antifoaming agent, up to about 50 wt % mild abrasive, and up to about 15 wt % pigment. Particularly, the coating composition may include between about 15 wt % and about 80 wt % resin binder, between about 20 wt % and about 85 wt % organic abrasive particles, up to about 5 wt % viscosity modifier, up to about 5 wt % surfactant, up to about 30 wt % plasticizer, up to about 10 wt % cross-linker, up to about 3 wt % antifoaming agent, up to about 25 wt % mild abrasive, and up to about 10 wt % pigment. More particularly, the coating composition may include between about 20 wt % and about 65 wt % resin binder, between about 35 wt % and about 80 wt % organic abrasive particles, up to about 2 wt % viscosity modifier, up to about 3 wt % surfactant, up to about 6 wt % plasticizer, up to about 6 wt % cross-linker, up to about 1 wt % antifoaming agent, up to about 15 wt % mild abrasive, and up to about 5 wt % pigment.

When used in a coating composition, the organic abrasive particles are incorporated into nonwoven lofty open mats formed from randomly disposed fibers which are thermal bonded with a binder slurry to be used as cleaning articles, such as scouring pads.

The cleaning article of the present invention generally includes a substrate and the coating composition disposed on the substrate. The substrate can be a nonwoven web constituted of a network of synthetic fibers or filaments which provide surfaces on which the abrasive particles are attached by the coating. Although the specification describes the substrate primarily as being a nonwoven, the substrate can be any material known in the art, including, but not limited to: a film or a foam. The resulting cleaning article including the organic abrasive particles has a cleaning efficacy of greater than about 0.9 panels cleaned in 1,000 cycles and a Schieffer Scratch performance rating of less than or equal to about 3.5.

In practice, to make a cleaning article of the present invention, the organic abrasive articles are incorporated into and/or onto a substrate by disposing the coating composition including the organic abrasive particles onto the substrate or by disposing a printed abrasive coating including the organic abrasive particles onto the substrate. In a first method, a substrate, such as a nonwoven web, is first impregnated with a binder resin. The substrate can be impregnated with the binder resin by any means known in the art. In one embodiment, the binder resin is roll-coated onto the substrate. The coated substrate is then dried and the binder resin is cured. The resultant pre-bonded, lofty nonwoven web is then spray coated on at least one major surface with a binder solution containing the organic abrasive crushed particles. The coated substrate is then dried and the binder is cured, forming a strong abrasive coating on the substrate.

In a second method, where the cleaning article is formed when the organic abrasive particles are incorporated in a printed abrasive coating, a slurry containing the organic abrasive crushed particles is coated onto the substrate in a process similar to the one described in PCT Publication WO2015123635, which is hereby incorporated by reference.

The resulting cleaning article including the substrate coated with the binder resin with the organic abrasive particles can efficiently and effectively clean a surface with minimal to no scratching of the surface. In one embodiment, the cleaning article cleans greater than about 0.9 panels in 1,000 cycles, particularly greater than about 1 panel in 1,000 cycles, more particularly greater than about 1.2 panels in 1,000 cycles, more particularly greater than about 1.5 panels in 1,000 cycles, and most particularly greater than about 2 panels in 1,000 cycles. In one embodiment, the cleaning article has a Schieffer scratch performance rating of less than or equal to about 3.5, and particularly less than or equal to about 3.0.

The present invention also describes a cleaning composition. The cleaning composition includes a carrier, organic abrasive particles, and abrasive particles. The carrier is one of water and surfactant, or a combination thereof. In one embodiment, the cleaning composition includes between about 0.1 and about 99.9 dry weight percent organic abrasive particles, between about 0.1 and about 80 dry weight percent abrasive particles, and between about 0 and about 30 dry weight percent carrier; particularly between about 20 and about 85 weight percent organic abrasive particles, between about 1 and about 70 dry weight percent abrasive particles, and between about 0.1 and about 5 weight percent carrier; and more particularly between about 35 and about 80 dry weight percent organic abrasive particles, between about 10 and about 30 weight percent abrasive particles, and between about 0.1 and about 3 dry weight percent carrier.

In one embodiment when the carrier is a surfactant, the cleaning composition includes between about 0.1 and about 90 weight percent organic abrasive particles, between about 0.1 and about 80 weight percent abrasive particles, and between about 0.1 and about 30 weight percent surfactant. Examples of suitable surfactants include, not are not limited to, ionic and anionic surfactants.

Examples of suitable abrasive particles include, but are not limited to: cerium oxide, nepheline syenite, clay, zirconium oxide, titanium oxide, and the like.

In one embodiment, the cleaning composition also includes a mild abrasive. Examples of mild abrasives include, but are not limited to: talc, calcium carbonate, melamine formaldehyde, calcium silicate, pumice, kaolins, clay, and the like.

Other materials can be added to the cleaning composition for special purposes, including, but not limited to: viscosity modifiers, surfactants, plasticizers, cross-linkers, antifoaming agents, mild abrasives, abrasives, pigments, acid catalysts, solvents, antifungal agents, and antimicrobial agents. Viscosity modifiers can be used to modify the viscosity of the formulation. Antifoaming agents can be used to defoam the formulation. Pigments can be added to give color to formulation. Antimicrobial agent can lend antimicrobial efficacy to article. Antifungal agent can lend antifungal efficacy to article. In one embodiment, the carrier may include between about 90 wt % and about 0.1 wt % organic abrasive particles, between about 80 wt % and about 0.1 wt % abrasive particles, between about 0.1 wt % and about 30 wt % surfactant, up to about 10 wt % viscosity modifier, up to about 5 wt % antifoaming agent, up to about 50 wt % mild abrasive, and up to about 15 wt % pigment. Particularly, the carrier may include between about 20 wt % and about 85 wt % organic abrasive particles, between about 70 wt % and about 1 wt % abrasive particles, up to about 5 wt % viscosity modifier, up to about 5 wt % surfactant, up to about 3 wt % antifoaming agent, up to about 25 wt % mild abrasive, and up to about 10 wt % pigment. More particularly, the coating may include between about 35 wt % and about 80 wt % organic abrasive particles, between about 60 wt % and about 10 wt % abrasive particles, up to about 2 wt % viscosity modifier, up to about 3 wt % surfactant, up to about 1 wt % antifoaming agent, up to about 15 wt % mild abrasive, and up to about 5 wt % pigment.

In one embodiment, the cleaning composition is in the form of a cleaning slurry. When the cleaning composition is a cleaning slurry, the cleaning slurry is formed when the organic abrasive particles are incorporated in a carrier to produce a cleaning slurry. A cleaning slurry can include a cleaning dispersion or cleaning emulsion.

The resulting cleaning composition can efficiently and effectively clean a surface with minimal to no scratching of the surface. In one embodiment, the cleaning composition cleans about 1 panel in about 150 cycles or less, particularly in about 100 cycles or less, and more particularly in about 50 cycles or less. In one embodiment, the clearing composition has a Slurry Scratch performance rating of less than about 5, particularly less than about 4, and more particularly less than about 2. In one embodiment, the cleaning composition has a Polish Performance rating of greater than 0, particularly greater than about 2, more particularly greater than 3, more particularly greater than about 4, and most particularly about 5.

Although the present invention has been described with reference to preferred embodiments, workers skilled in the art will recognize that changes may be made in form and detail without departing from the spirit and scope of the invention.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Materials

| Component Name | Description | Function | Supplier |
|---|---|---|---|
| Liquid Urea | Thermosetting Urea | Binder | Arclin, North Bay, Ontario, Canada |
| Formaldehyde Resin B3 | Formaldehyde Resin | | |
| 80-5077A Liquid Phenol | Thermosetting | Binder | Arclin, North Bay, Ontario, Canada |
| Formaldehyde Resin | Phenolic Resin | | |
| Acrodur ® DS 3515 | Styrene Acrylic Resin | Binder | BASF Corporation, |
| | | | Florham Park, New Jersey, USA |
| Alberdingk ® U9380 | Polyurethane Resin | Binder | Alberdingk Boley, Inc., Greensboro, |
| | | | North Carolina, USA |
| Alberdingk ® U6150 | Polyurethane Resin | Binder | Alberdingk Boley, Inc., Greensboro, |
| | | | North Carolina, USA |
| Rhoplex GL-618 | Acrylic Resin | Plasticizer | DOW Chemical Company, Midland, |
| | | | Michigan, USA |
| Rovene ® 5900 | Styrene Butadiene | Plasticizer | Mallard Creek Polymers, Inc., |
| | Resin | | Charlotte, North Carolina, USA |
| Hycar ® 2679 | Acrylic Resin | Plasticizer | The Lubrizol Corporation, |
| | | | Wickliffe, Ohio, USA |
| Hycar ® 26796 | Acrylic Resin | Plasticizer | The Lubrizol Corporation, |
| | | | Wickliffe, Ohio, USA |
| Hycar ® 26315 | Acrylic Resin | Plasticizer | The Lubrizol Corporation, |
| | | | Wickliffe, Ohio, USA |
| Cymel ® 303 LF | Amino Crosslinker | Cross-Linker | Allnex USA Inc., Alpharetta, |
| | | | Georgia, USA |
| Cymel ® 385 | Amino Crosslinker | Cross-Linker | Allnex USA Inc., Alpharetta, |
| | | | Georgia, USA |
| Aluminum Chloride | Acid Catalyst | Catalyst | GEO Specialty Chemicals, Inc, |
| Solution | | | Ambler, Pennsylvania, USA |
| Ammonium Chloride | Acid Catalyst | Catalyst | Zaclon LLC, Cleveland, Ohio, USA |
| Solution | | | |
| Diammonium Phosphate | Acid Catalyst | Catalyst | Innophos Holdings, Inc., Cranbury, |
| Food Grade | | | New Jersey, USA |
| CAB-O-SIL ® M5 | Viscosity Modifier | Viscosity | Cabot Corporation, |
| | | Modifier | Billerica, Massachusetts, USA |
| Laponite ® RD | Viscosity Modifier | Viscosity | BYK USA Inc., Gonzales, |
| | | Modifier | Texas, USA |
| Gemtex SC-85-P | Surfactant | Surfactant | Innospec Performance Chemicals, |
| | | | Salisbury, North Carolina, USA |
| Dynol ™ 604 | Surfactant | Surfactant | Air Products and Chemicals, Inc., |
| | | | Allentown, Pennsylvania, USA |
| Arcol ® LG-650 | Surfactant | Surfactant | Bayer Material Science LLC, |
| | | | Pittsburgh, Pennsylvania, USA |
| Tergitol ™ 15-S-5 | Non-Ionic Surfactant | Surfactant | DOW Chemical Company, Midland, |
| | | | Michigan, USA |
| Acrysol ™ RM-8W | Non-Ionic Surfactant | Surfactant | DOW Chemical Company, Midland, |
| | | | Michigan, USA |
| Xiameter ® AFE 1520 | Antifoaming Agent | Anti-foaming | DOW Chemical Company, Midland, |
| | | Agent | Michigan, USA |
| Zinc Omadine ® | Zinc Pyrithione | Anti-microbial | Arch Chemicals, INC. |
| | | Agent | Norwalk, Connecticut, USA |
| Minstron ® 353 Talc | Abrasive | Mild Abrasive | Imerys Talc America, Inc., Three |
| | | | Forks, Montana, USA |
| Snowhite ® 12 Calcium | Abrasive | Mild Abrasive | Omya Canada Inc., Perth, Ontario, |
| Carbonate | | | Canada |
| USG Terra Alba No. 1 | Abrasive | Mild Abrasive | USG Corporation, |
| Calcium Sulfate | | | Chicago, Illinois, USA |
| Recycled Glass (40-70 | Abrasive | Abrasive | ESCA Industries, Ltd., |
| Grit) | | | Hatfield, Pennsylvania, USA |
| Sunsperse Blue 15 | Pigment Dispersion | Pigment | Sun Chemical Corporation, |
| | | | Parsippany, New Jersey, USA |
| Sunsperse Violet 23 | Pigment Dispersion | Pigment | Sun Chemical Corporation, |
| | | | Parsippany, New Jersey, USA |
| Sun Black | Pigment Dispersion | Pigment | Sun Chemical Corporation, |
| | | | Parsippany, New Jersey, USA |
| Blue Pigment B2G | Pigment Dispersion | Pigment | Clariant Ltd., Charlotte, North |
| | | | Carolina, USA |
| 15D × 38 mm | Staple Fiber | Fiber | Stein Fibers, LTD, Albany, New |
| Polyethylene | | | York, USA |
| Terephthalate Staple | | | |
| Fiber | | | |
| Hubercarb ® Q325 | Abrasive | Abrasive | Huber Engineered Materials, |
| CaCO₃ | | | Atlanta, GA, USA |
| CeO₂ | Abrasive | Abrasive | PIDC, Inc., Ann Arbor, MI USA |
| Stepanol WA-Extra | Anionic Surface | Surfactant | Stepan, Northfiled, IL USA |
| Sodium Lauryl Sulfate | | | |
| Tomadol 91-6 C9-11 | Non-ionic | Surfactant | Air Products and Chemicals, |
| Ethoxylated alcohol | | | Allentown, PA, USA |
| Dowanol ® PnB | Solvent | Solvent | Dow chemicals, Midland, MI, USA |
| Propylene glycol | | | |
| n-butyl | | | |
| ether | | | |
| Acusol ™ 820 | Thickener | Thickener | Dow chemicals, Midland, MI, USA |
| NaOH | Sodium hydroxide | Base | Sigma-Aldrich, St. Louis, MO, |
| | | | USA |
| Scotch-Brite ™ Heavy | Nonwoven scouring | Commercial | 3M Company, St. Paul Minnesota, |
| Duty Scouring Pad | pad | Product, Comp. | USA |
| | | Example F | |
| Scotch-Brite ™ | Nonwoven scouring | Commercial | 3M Company, St. Paul Minnesota, |
| Non-Scratch Scouring Pad | pad | Product, Comp. | USA |
| | | Example G | |
| Scotch-Brite ™ Dual | Printed Abrasive | Commercial | 3M Company, St. Paul Minnesota, |
| Purpose Scour Pad | Scouring Pad | Product, Comp. | USA |
| 96HEX | | Example H | |
| Dawn ™ Non-Scratch | Nonwoven Scrub | Commercial | Butler Home Products, LLC, |
| Premium Scrubber | Sponge | Product, Comp. | Hudson, Massachusetts, USA |
| Sponge | | Example I | |
| Weiman ® Cooktop | Cleaning Surry | Commercial | Weiman Products LLC, Gurnee, IL, |
| Cleaner | | Product | USA |
| Soft Scrub ® Total All | Cleaning Slurry | Commercial | Henkel Corporation, Stamford, CT, |
| Purpose | | Product | US |
| Weiman ® Cooktop | Cleaning Surry | Commercial | Weiman Products LLC, Gurnee, IL, |
| Cleaner | | Product | USA |

### Preparation of Particles

The organic crushed particles were prepared as follows. The ingredients were weighed to the nearest 0.1 grams in separate plastic containers in desired quantities. A mixture was prepared by placing all ingredients sequentially into a rigid plastic container while mixing with a laboratory air stirrer mixer commercially available from INDCO Inc, New Albany Ind., USA under model number AS15D. The prepared solution was then cast in an aluminum or glass pan and cured in an oven at 275° F. for 4 hours. The resulting cured resin matrix was then mechanically crushed using a Waring® Blender (Conair Corporation, Stamford, Conn., USA). The final crushed particles were sieved to the desired particle size, ranging from 100-600 microns and would pass through a 30-mesh sieve and be retained upon a 140-mesh sieve. Formulations (FM) 1-9 are provided in Table 1.

TABLE 1

| | FM 1 | FM 2 | FM 3 | FM 4 | FM 5 | FM 6 | FM 7 | FM 8 | FM 9 |
|---|---|---|---|---|---|---|---|---|---|
| Components | wt (%) | wt (%) | wt (%) | wt (%) | wt (%) | wt (%) | wt (%) | wt (%) | wt (%) |
| Liquid Urea | 67.6% | 79.0% | 83.7% | 79.3% | 75.4% | 79.3% | 30.0% | 90.0% | — |
| Formaldehyde | | | | | | | | | |
| Resin B3 | | | | | | | | | |
| 80-5077A Liquid | — | — | — | — | — | — | — | — | 100.0% |
| Phenol Formaldehyde | | | | | | | | | |
| Resin | | | | | | | | | |
| Acrodur ® DS 3515 | — | — | — | — | — | 5.3% | — | — | — |
| Rhoplex GL-618 | — | 6.0% | — | — | — | — | — | 8.2% | — |
| Hycar ® 2679 | — | — | — | 6.0% | — | — | — | — | — |
| Rovene ® 5900 | — | — | 14.6% | — | — | — | — | — | — |
| Cymel ® 303 LF | — | — | — | — | 6.3% | — | — | — | — |
| Minstron ® 353 Talc | — | 13.7% | — | 13.8% | 13.1% | 13.8% | — | — | — |
| Ammonium | 1.4% | 1.1% | 0.5% | 1.1%. | 1.2% | 1.4% | — | — | — |
| Chloride Solution | | | | | | | | | |
| Aluminum | 0.2% | 0.2% | 0.2% | 0.2% | 0.9% | 2.6% | — | — | — |
| Chloride Solution | | | | | | | | | |
| Diammonium | — | — | — | — | — | — | — | 1.4% | — |
| Phosphate Food Grade | | | | | | | | | |
| Tergitol ™ 15-S-5 | — | — | 1.0% | — | — | — | — | — | — |
| Arcol ® LG-650 | 0.8% | — | — | — | — | — | — | — | — |
| Xiameter ® AFE 1520 | 0.04% | — | — | — | — | — | — | — | — |
| Sunsperse Violet 23 | 0.1% | — | — | — | — | — | — | — | — |
| USG Terra Alba | 29.8% | — | — | — | — | — | 70.0% | — | — |
| No. 1 Calcium | | | | | | | | | |
| Sulfate | | | | | | | | | |
| Zinc Omadine ® | — | — | — | — | — | — | — | 0.3% | — |

### Preparation of Articles

### Examples 1-8 and Comparative Examples A-E

A lofty nonwoven web was prepared from size 17 dtex (15 denier) polyethylene tetraphatalate fiber (PET). The nonwoven web was formed on a conventional air-laying web forming machine (available from the Rando Machine Corporation, Macedon, N.Y., under the trade designation “RANDO-WEBBER”). The thickness of the nonwoven web ranged from 7.0-10.0 mm and the area weight (basis weight) of the web ranged from 110 to 300 grams per square meter (gsm). The nonwoven web was then impregnated with a thermosetting binder resin using a standard two-roll coater. The coated web was then dried and the binder resin cured by passing the coated web through an oven having a temperature ranging from 100−250° C., yielding a prebonded, lofty nonwoven web. The amount of prebond resin solution coated as dry solids ranged from 100-300 gsm.

The resultant prebonded, lofty nonwoven web was then spray coated on one major surface with a binder solution containing the organic abrasive crushed particles to a wet add-on basis weight of 100-400 gsm. The binder solutions containing organic crushed particles described in Examples (EX) 1-8 are provided in Table 2 and Comparative Examples (CEX) A-E are provided in Table 3. The coated web was then dried and the binder cured by passing the web through an oven having a temperature ranging from 100-250° C. to form a strong abrasive coating on the lofty nonwoven web.

TABLE 2

| | EX 1 | EX 2 | EX 3 | EX 4 | EX 5 | EX 6 | EX 7 | EX 8 |
|---|---|---|---|---|---|---|---|---|
| Components | wt (%) | wt (%) | wt (%) | wt (%) | wt (%) | wt (%) | wt (%) | wt (%) |
| Laponite ® RD | 0.23% | — | 0.73% | — | 0.73% | — | 0.73% | — |
| 80-5077A Liquid | 24.73% | — | 21.81% | — | 21.81% | — | 21.81% | — |
| Phenol Formaldehyde | | | | | | | | |
| Resin | | | | | | | | |
| Acrodur ® DS 3515 | — | 29.8% | — | — | — | 29.80% | — | — |
| Alberdingk ® U9380 | — | — | — | 21.04% | — | — | — | — |
| Alberdingk ® U6150 | — | — | — | — | — | — | — | 34.3% |
| Rovene ® 5900 | 2.63% | — | — | — | — | — | — | — |
| Hycar ® 26796 | — | — | 4.10% | — | 4.10% | 5.04% | 4.10% | — |
| Hycar ® 26315 | — | 5.04% | — | — | — | — | — | — |
| Cymel ® 385 | — | — | — | 6.37% | — | — | — | 13.3% |
| Sunsperse Blue 15 | 0.17% | 0.10% | 0.11% | 0.16% | 0.11% | 0.10% | 0.11% | — |
| Sunsperse Violet 23 | — | — | — | — | — | — | — | 0.09% |
| Xiameter ® AFE 1520 | 0.03% | 0.04% | 0.04% | 0.04% | 0.04% | 0.04% | 0.04% | 0.22% |
| Acrysol RM-8W | — | — | — | — | — | — | — | 0.37% |
| Snowhite ® 12 | 12.89% | — | — | — | — | — | — | — |
| Calcium Carbonate | | | | | | | | |
| Formulation 1 | 59.31% | 65.02% | — | — | — | — | — | — |
| Formulation 2 | — | — | 73.21% | — | — | — | — | — |
| Formulation 3 | — | — | — | 72.40% | — | — | — | — |
| Formulation 4 | — | — | — | — | 73.21% | — | — | — |
| Formulation 5 | — | — | — | — | — | 65.02% | — | — |
| Formulation 6 | — | — | — | — | — | — | 73.21% | — |
| Formulation 8 | — | — | — | — | — | — | — | 51.67% |

TABLE 3

| | CEX A | CEX B | CEX C | CEX D | CEX E |
|---|---|---|---|---|---|
| Components | wt (%) | wt (%) | wt (%) | wt (%) | wt (%) |
| Laponite ® RD | 0.23% | — | — | — | — |
| Rhoplex GL-618 | — | 80.0% | 50.0% | — | — |
| 80-5077A Liquid | 24.7% | — | — | 50.0% | 25.0% |
| Phenol | | | | | |
| Formaldehyde Resin | | | | | |
| Rovene ® 5900 | 2.6% | — | — | — | — |
| Hycar ® 2676 | — | — | — | — | 5.0% |
| Sunsperse Blue 15 | 0.2% | — | — | — | — |
| Xiameter ® AFE | 0.03% | — | — | — | — |
| 1520 | | | | | |
| Snowhite ® 12 | 12.9% | — | — | — | — |
| Calcium Carbonate | | | | | |
| Recycled Glass | 59.3% | — | — | — | — |
| (40-70 Grit) | | | | | |
| Formulation 7 | — | 20.0% | — | — | — |
| Formulation 8 | — | — | 50.0% | 50.0% | — |
| Formulation 9 | — | — | — | — | 70.0% |

### Example 9

A binder slurry containing organic abrasive crushed particles was coated onto a lofty nonwoven web in a process similar to that described e.g. in U.S. Published Application 2017/0051442 to Endle. The formulation of the binder slurry is provided in Table 4.

TABLE 4

| Components | Wt (%) |
|---|---|
| BB-077 Phenolic Resin | 25.63% |
| Rovene 5900 | 3.88% |
| Sun Black | 0.35% |
| Xiameter AFE 1520 | 0.07% |
| Calcium Carbonate | 12.51% |
| Formulation 5 | 57.56% |

### Examples 10-16 and Comparative Examples F

Particles prepared using the formulation FM8 in Table 1 underwent an additional crushing step using a Waring® Blender (Conair Corporation, Stamford, Conn., USA). The final crushed particles were sieved to the three desired particle sizes: UFP-150, UFP-100, and UFP-50 respectively so that UFP-150 would pass through 100-mesh and be retained upon 140-mesh, UFP-100 would pass through 140-mesh and be retained upon a 270-mesh, and UFP-50 would pass through 270-mesh. The ingredients were weighed to the nearest 0.1 grams in separate plastic containers in desired quantities. A cleaning composition was prepared by placing all ingredients sequentially into a rigid plastic container while mixing with a laboratory air stirrer mixer commercially available from INDCO Inc, New Albany Ind., USA under model number AS15D. Examples (EX) 10-16 and Comparative Examples (CEX) F are provided in Table 5.

TABLE 5

| | CEX-F | EX-10 | EX-11 | EX-12 | EX-13 | EX-14 | EX-15 | EX-16 |
|---|---|---|---|---|---|---|---|---|
| CaCO₃ | 16.03 | 13.01 | — | — | — | — | — | — |
| CeO₂ | — | 3.01 | — | 3.01 | — | 3.00 | — | 3.01 |
| UFP-150 | — | — | 16.02 | 13.06 | — | — | — | — |
| UFP-100 | — | — | — | — | 16.00 | 13.00 | — | — |
| UFP-50 | — | — | — | — | — | — | 16.05 | 13.00 |
| Gemtex SC-85-P | 0.12 | 0.12 | 0.12 | 0.12 | 0.12 | 0.12 | 0.12 | 0.12 |
| Stepanol WA-Extra | 0.51 | 0.50 | 0.51 | 0.50 | 0.51 | 0.53 | 0.52 | 0.50 |
| Tomadol 91-6 | 0.51 | 0.50 | 0.51 | 0.52 | 0.52 | 0.54 | 0.51 | 0.51 |
| Dowanol PnB | 0.30 | 0.30 | 0.30 | 0.30 | 0.30 | 0.31 | 0.31 | 0.32 |
| NaOH (4%) | 2.53 | 2.54 | 4.51 | 4.33 | 4.35 | 4.36 | 4.35 | 4.37 |
| Acusol 820 | 1.88 | 2.07 | 1.86 | 1.97 | 1.97 | 1.97 | 1.97 | 1.94 |
| Water | 78.16 | 77.90 | 76.2 | 76.19 | 76.24 | 76.18 | 76.16 | 77.24 |

### Test Methods

### Schiefer Scratch Test

Schiefer scratch testing was performed to evaluate the relative abrasiveness of the coated nonwoven scouring materials. The test was performed in a generally similar manner as described in U.S. Pat. No. 5,626,512 (Palaikis et al). The nonwoven scouring materials tested were cut into a circular pad (8.25 cm in diameter). The test was conducted with the nonwoven scouring pad rotating at 250 rpm for 5000 revolutions under a load of 2.25 kg with water applied to the surface of the circular acrylic work piece (10.16 cm in diameter) at a rate of 40-60 drops per minute. Results are given as a visual rating, or an average of a visual rating of three samples, from 1 to 5 of the scratch pattern remaining on the acrylic disk. The Schiefer scratch visual ratings of 1-5 are provided in Table 6.

TABLE 6

| Visual | | Acceptance |
|---|---|---|
| Rating | Description | Criteria |
| 1 | No visible scratches to very light scratches. | Pass |
| 2 | Scratches are light, but more frequent and more | Pass |
| | visible. | |
| 3 | Scratches are light, but more visible with | Pass |
| | well-defined scratch patterns. | |
| 4 | Easily visible scratch pattern covering entire | Fail |
| | with well-defined scratch patterns. | |
| 5 | Scratch pattern so frequent entire workpiece is | Fail |
| | opaque and weight loss of the sample is observed. | |

### Article Cleaning Efficacy Test

The article cleaning efficacy test was performed in a generally similar manner as that described in U.S. Pat. No. 5,626,512 (Palaikis et al). A 5.08 cm×22.86 cm 18 gauge stainless steel panel was coated with a food soil mixture made up of 120 grams milk, 60 grams cheddar cheese, 120 grams hamburger, 120 grams tomato juice, 120 grams cherry juice, 20 grams flour, and 100 granulated sugar, and one egg. The coated panel was baked in an oven at 230° C. for one hour. The above coating and curing process was repeated three times to achieve uniform coat on the panel. Acceptable food soil coating weight should be at least equal to 1.0 grams. The coated panel was then fully submerged in a tray containing approximately 250 ml of a 4% aqueous dish soap solution. A 7.5 cm×10.0 cm pad of the cleaning article was inserted into the holder of a Gardner Heavy Duty Wear Tester. The cleaning article was then run back and forth on the coated panel under an applied force of 2.25 kg until the coated panel was clean (no coated material visually remained on the panel). The number of cycles (back and forth equals one cycle with a rate of approximately 43 cycles per minute) required to result in a clean panel was recorded. If 1,000 cycles was not reached, an additional food soil panel was then placed in the tray. Results are given in the number of panels cleaned in 1,000 cycles.

### Mohs Hardness Test

Mohs hardness testing was performed to evaluate the degree of hardness of the resin systems using in the manufacture of the organic abrasive particles. The test was performed using a Mohs hardness testing kit (Mineralab LLC, Prescott, Ariz., USA). The kit contains picks ranging from Mohs' Hardness of 2.0 to Mohs' hardness of 9.0. A 5.08 cm×22.86 cm 18 gauge stainless steel panel was coated using a 60 RDS Mayer Rod with the resin system being evaluated. The coated panel was then cured at 280 F for 1 hour. A Mohs' hardness pick was selected and held at 70 degrees to the sample. The pick was pressed down and the pick hardness point scratched across the sample surface. If the pick scratched the material, then the material was softer than the hardness point. The material was scratched with the next softest pick until the material could no longer be scratched. The material's Mohs hardness is then defined at the midpoint between the pick that scratches the material and the next softest pick that does not.

### Antimicrobial Efficacy Test for Organic Particles (Reference AATCC 100)

An antimicrobial efficacy test was performed to evaluate the degree of antimicrobial efficacy of the organic abrasives. A suspension of the bacteria to be used in testing was made in a 0.1% peptone water solution of the same turbidity as a 0.5 McFarland Equivalence Turbidity standard. This standard typically yields a bacteria count of approximately 1.5×10\hat{ }8 colony forming units (CFU) per millimeter. Test organisms used were Staphylococcus aureus (ATCC 6538) and Escherichia coli (ATCC11229). The test was performed using 1.0 g of the organic abrasive particles. The organic abrasive particles were placed into a sterile Whirl Pack™ bags followed by 19 mL of bacteria suspension. The plastic bag was sealed and the bag manually squeezed repeatedly in order to distribute the bacteria solution evenly over the organic abrasive particles. The bags with the organic abrasive particles were allowed to incubate at 25° C. for 24 hours. The liquid was withdrawn from the bag and serial dilutions were plated on 3M Petrifilm™ plate (1 mL) until countable range was achieved. Plates were incubated at 35 C for 24 hours and counted using a 3M Petrifilm™ plate reader. The percentage reduction of the bacterial load introduced into the organic abrasive particles was reported.

### Antimicrobial Efficacy Test for Nonwovens Cleaning Article (Reference AATCC 100)

An antimicrobial efficacy test was performed to evaluate the degree of antimicrobial efficacy of the nonwoven scour pad cleaning articles. A suspension of the bacteria to be used in testing was made in a 0.1% peptone water solution of the same turbidity as a 0.5 McFarland Equivalence Turbidity standard. This standard typically yields a bacteria count of approximately 1.5×10\hat{ }8 colony forming units (CFU) per millimeter. Test organisms used were Staphylococcus aureus (ATCC 6538) and Escherichia Coli (ATCC11229). The test was performed using a nonwoven scour pad sample cut to 1.0 in×1.0 in sample. The nonwoven scour pad samples were placed into a sterile Whirl Pack™ bags followed by 19 mL of bacteria suspension. The plastic bag was sealed and the bag manually squeezed repeatedly in order to distribute the bacteria solution evenly over nonwoven scour pad sample. The bags with the nonwoven scour pads were allowed to incubate at 25° C. for 24 hours. The liquid was withdrawn from the bag and serial dilutions were plated on 3M Petrifilm™ plate (1 mL) until countable range was achieved. Plates were incubated at 35 C for 24 hours and counted using a 3M Petrifilm™ plate reader. The percentage reduction of the bacterial load introduced into the nonwoven articles was reported.

### Slurry Scouring Test

A single-coated food soil panel was prepared on a 5.08 cm×22.86 cm 18 gauge stainless steel panel. The panel was coated with a food soil mixture made up of 120 grams milk, 60 grams cheddar cheese, 120 grams hamburger, 120 grams tomato juice, 120 grams cherry juice, 20 grams flour, and 100 granulated sugar, and one egg. The coated panel was baked in an oven at 230° C. for one hour. Approximately 0.5 g of slurry was added onto the food soil panel. A Kimwipes™ is used to clean by hand a ¾″×2″ designated area of the panel surface area using a back and forth motion. This motion is repeated continuously until 70% of the designated area is visually clean. One back and forth motion is counted as 1 cycle. The results are giving the amount of cycles needed to clean the designated area to 70% clean.

### Slurry Scratch Test

Approximately 0.5 g of cleaning slurry was added onto a 5 cm×5 cm designated area of a Schott glass cooktop panel. A Kimwipe™ was used to clean the area by hand with a back and forth motion for 30 seconds. The area was then rinsed with water, cleaned and dried. The process was repeated 10 times. The visual scratch on the glass surface was rated under an optical microscope on the scale from 0 to 5 following the rating system in Table 7.

TABLE 7

| Microscope | |
|---|---|
| Rating | Description |
| 0 | No scratches at all |
| 1 | No observable scratches to very little light line scratches |
| 2 | Scratches are light, but more frequent and more |
| | observable |
| 3 | Scratches are light, but more observable with well-defined |
| | scratch patterns. |
| 4 | Easily observable scratch pattern covering entire with |
| | well-defined scratch patterns. |
| 5 | Scratch pattern so frequent entire workpiece is opaque and |
| | weight loss of the sample is observed. |

### Polishing Test

A haze, as defined a dulled scratched surface, was created on Schott glass cooktop panel using the following process. A 10 cm×10 cm designated area on the glass panel was selected and 0.5 g Bar Keepers Friend (Multipurpose Cooktop Cleaner) was added. A Kimwipe™ was used to wipe the slurry in back and forth for 60 seconds in the designated area. This process was repeated three times so that that three lines were generated in the designated area. The surface was then rinsed with water, cleaned, and dried. Approximately 0.5 g of cleaning slurry being tested was added onto the designated area of the glass panel and wiped with a Kimwipe™ in a perpendicular direction to the haze in a back and forth motion for 60 seconds. The area was then rinsed with water, cleaned, and dried. After that, the polishing result was rated under microscope on the scale from 1 to 5 as follows in Table 8.

TABLE 8

| Microscope | |
|---|---|
| Rating | Description |
| 0 | 0% polished, no haze removed |
| 1 | 1-20% polished |
| 2 | 21-40% polished |
| 3 | 41-60% polished |
| 4 | 61-80% polished |
| 5 | 81-100% polished |

### Performance Testing

Examples (EX) 1-8 and Comparative Examples (CEX) A-I were tested to determine Mohs Hardness, Schieffer Scratch Rating, and the number of panels cleaned in 1,000 cycles. The results of the testing and whether the Examples or Comparative Example passed the tests are listed in Table 9.

TABLE 9

| | | | Schieffer | | | |
|---|---|---|---|---|---|---|
| | Mohs | | Scratch | | # Panels | |
| | Hardness of | Mohs | Rating | Schieffer | Cleaned in | Cleaning |
| | Abrasive | Hardness | (Visual | Scratch | 1,000 | Efficacy |
| | Particle | Result | Rating 1-5) | Result | Cycles | Result |
| Example 1 | 3.5 | Pass | 3.0 | Pass | 5.06 | Pass |
| Example 2 | 3.5 | Pass | 2.0 | Pass | 1.07 | Pass |
| Example 3 | 3.5 | Pass | 1.0 | Pass | 1.77 | Pass |
| Example 4 | 3.5 | Pass | 1.0 | Pass | 0.94 | Pass |
| Example 5 | 2.5 | Pass | 1.0 | Pass | 1.91 | Pass |
| Example 6 | 3.5 | Pass | 1.0 | Pass | 3.04 | Pass |
| Example 7 | 3.5 | Pass | 1.0 | Pass | 1.29 | Pass |
| Example 8 | 3.5 | Pass | 1.0 | Pass | 1.80 | Pass |
| Example 9 | 3.5 | Pass | 3.5 | Pass | 1.87 | Pass |
| CEX A | 5.5 | Fail | 4.0 | Fail | — | — |
| CEX B | 3.5 | Pass | 2.5 | Pass | 0.71 | Fail |
| CEX C | 3.5 | Pass | 1.0 | Pass | 0.74 | Fail |
| CEX D | 3.5 | Pass | 4.0 | Fail | 3.17 | Pass |
| CEX E | 3.5 | Pass | 4.0 | Fail | 4.18 | Pass |
| CEX F (Commercial | 9.0 | Fail | 5.0 | Fail | 2.50 | N/A |
| Scotch-Brite ™ | | | | | | |
| Heavy Duty) | | | | | | |
| CEX G (Commercial | None | N/A | 2.0 | Pass | 0.88 | Fail |
| Scotch-Brite ™ | | | | | | |
| Non-Scratch) | | | | | | |
| CEX I (Commercial | Unknown | N/A | 2.0 | Pass | 0.61 | Fail |
| Dawn ™ | | | | | | |
| Non-Scratch) | | | | | | |
| CEX H (Commercial | 9.0 | Fail | 5.0 | Fail | 14.2 | Pass |
| Scotch-Brite ™ Dual | | | | | | |
| Purpose Scour Pad | | | | | | |
| 96HEX) | | | | | | |

As can be seen in Table 9, all of Examples 1-9, which included abrasive particles having a Mohs hardness of between 2 and 5, passed both the Schieffer Scratch test as well as cleaned greater than at least 0.9 panels per 1,000 cycles. By contrast, Comparative Examples A, F and H, which included abrasive particles having a Mohs hardness of greater than 5.5, had Schieffer Scratch ratings of greater than 3.5, leaving visible scratches on the surfaces being cleaned. While Comparative Examples B and C had abrasive particles having a Mohs hardness of 3.5 and passed the Schieffer Scratch test, they cleaned less than 0.9 panels per 1,000 cycles. And while the abrasive particles of Comparative Examples D and E had Mohs hardness levels of between 2 and 5 and cleaned more than 0.9 panels per 1,000 cycles, they had Schieffer Scratch ratings of over 3.5, with visible scratching on the surfaces being cleaned. Comparative Examples G and I, which did not include abrasive particles, cleaned less than 0.9 panels per 1,000 cycles.

Formulations 2 and 7, Example 8, and Comparative Example F were tested to determine the reduction of S. Aureus and E. Coli. The results of the testing are listed in Table 10.

TABLE 10

| | Reduction of | | Reduction of | |
|---|---|---|---|---|
| Example | S. Aureus (%) | Result | E. Coli (%) | Result |
| Formulation 7 | 100.000% | Reduction | 100.000% | Reduction |
| (treated) | | | | |
| Formulation 2 | 99.869% | Reduction | 99.918% | Reduction |
| (untreated) | | | | |
| Example 8 | 91.638% | Reduction | 57.366% | Minimal |
| (treated) | | | | Reduction |
| Comparative | +1.275% | Growth | 19.631% | Negligible |
| Example F | | | | |
| (untreated) | | | | |

As can be seen by the results in Table 10, Formulations 2 and 7 and Example 8 of the present invention all had a reduction of S. Aureus and E. Coli. Thus, when an antimicrobial agent is included in the organic abrasive particles and incorporated into the coated web of the present invention, a reduction is seen for both S. Aureus and E. Coli. By contrast, Comparative Example F either had no growth or negligible reduction of S. Aureus and E. Coli, respectively.

Examples 10-16 and Comparative Example F were tested to determine the slurry scouring, slurry scratching, and polishing performance as shown in Table 11.

TABLE 11

| | Slurry Scouring | Slurry Scratching | Polishing |
|---|---|---|---|
| | (# cycles) | (0-5) | (0-5) |
| CEX-F | >150 | 1 | 0 |
| EX-10 | 145 | 1 | 1 |
| EX-11 | 30 | 1 | 1 |
| EX-12 | 36 | 1 | 3 |
| EX-13 | 42 | 1 | 1 |
| EX-14 | 42 | 1 | 3 |
| EX-15 | 47 | 0 | 2 |
| EX-16 | 51 | 0 | 4 |
| Weiman ® | 83 | 5 | 0 |
| Cooktop Cleaner | | | |
| Soft Scrub ® Total | — | 5 | 0 |
| All Purpose | | | |

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. The present invention may suitably comprise, consist of, or consist essentially of, any of the disclosed or recited elements. As used herein, the term “consisting essentially of” does not exclude the presence of additional materials which do not significantly affect the desired characteristics of a given composition or product. In particular, any of the elements that are positively recited in this specification as alternatives, may be explicitly included in the claims or excluded from the claims, in any combination as desired. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

1. A cleaning article comprising:
a substrate; and
organic abrasive particles dispersed within the substrate,
wherein the organic abrasive particles have a Mohs hardness of between about 2.0 and about 5.0,
wherein the cleaning article cleans greater than about 0.9 panels in 1,000 cycles, and
wherein the cleaning article has a Schieffer Scratch performance rating of less than or equal to about 3.5.

2. The cleaning article of claim 1, wherein the organic abrasive particles comprise an acid catalyst.

3. The cleaning article of claim 1, wherein the organic abrasive particles are dispersed within a coating.

4. (canceled)

5. The cleaning article of claim 1, wherein the organic abrasive particles have a Mohs hardness of between about 2.0 and about 4.0.

6. (canceled)

7. The cleaning article of claim 1, wherein the organic abrasive particles comprises a resin binder.

8. (canceled)

9. The cleaning article of claim 1, wherein the cleaning article cleans greater than about 1.2 panels in 1,000 cycles.

10. The cleaning article of claim 1, wherein the cleaning article has a Schieffer Scratch performance rating of less than or equal to about 3.0.

11. (canceled)

12. A cleaning article comprising:
a substrate; and
a coating dispersed on the substrate, the coating comprising organic abrasive particles having a Mohs hardness of between about 2.0 and about 5.0,
wherein the cleaning article cleans greater than about 0.9 panels in 1,000 cycles, and
wherein the cleaning article has a Schieffer Scratch performance rating of less than or equal to about 3.5.

13. (canceled)

14. The cleaning article of claim 12, wherein the organic abrasive particles comprises a resin binder.

15. The cleaning article of claim 12, wherein the organic abrasive particles comprise at least one of a plasticizer, an acid catalyst, a cross-linker, a surfactant, a mild-abrasive, and an antibacterial agent.

16. The cleaning article of claim 12, w-herein the organic abrasive particles have a Mohs hardness of between about 2.0 and about 4.0.

17. A cleaning composition comprising:
between about 0.1 and about 99.9 dry weight percent organic abrasive particles;
between about 0.1 and about 80 dry weight percent abrasive particles; and
between about 0 and about 30 dry weight percent carrier,
wherein the organic abrasive particles have a Mohs hardness of between about 2.0 and about 5.0,
wherein the cleaning composition cleans about 1 panel in about 150 cycles or less,
wherein the cleaning composition has a Slurry Scratch performance rating of less than about 5, and
wherein the cleaning composition has a Polish Performance rating of greater than 0.

18. The cleaning composition of claim 17, wherein the carrier is at least one of water and a surfactant.

19. (canceled)

20. The cleaning composition of claim 17, wherein the organic abrasive particles comprises a resin binder.

21. The cleaning composition of claim 17, wherein the cleaning composition is a cleaning slurry.

22. (canceled)

23. The cleaning composition of claim 17, wherein the cleaning composition cleans about 1 panel in about 50 cycles or less.

24. The cleaning composition of claim 17, wherein the cleaning composition has a Slurry Scratch performance rating of less than about 2.

25. The cleaning composition of claim 17, wherein the cleaning composition has a Polish Performance rating of greater than about 2.

26. A coating composition for a cleaning article, the composition comprising:
between about 0.1 and about 90 weight percent resin binder; and
between about 10 and about 90 weight percent organic abrasive particles,
wherein the organic abrasive particles have a Mohs hardness of between about 2.0 and about 5.0,
wherein the cleaning article cleans greater than about 0.9 panels in 1,000 cycles, and
wherein the cleaning article has a Schieffer Scratch performance rating of less than or equal to about 3.5.

27. (canceled)

28. (canceled)

29. The coating composition of claim 26, wherein the organic abrasive particles comprises a resin binder.
